(19) United States
(12) Patent Application Publication
(10) Pub. No.: US 2026/0340076 A1
(43) Pub. Date: Oct. 29, 2026

(54) CKM / PMNS ANGLE SYNTHESISER - METHODS AND SYSTEMS FOR PARAMETER- FREE UNITARY MIXING MATRICES VIA GOLDEN-RATIO LADDER-INDEX DIFFERENCES

(71) Applicant: Jonathan Washburn, Austin, TX (US)

(72) Inventor: Jonathan Washburn, Austin, TX (US)

(21) Appl. No.: 19/650,737

(22) Filed: Apr. 17, 2026

Related U.S. Application Data
(60) Provisional application No. 63/794,584, filed on Apr. 25, 2025.

(51) Int. Cl. G06F 17/16

(52) U.S. Cl. CPC G06F 17/16

(57) ABSTRACT

A computer-implemented synthesis architecture generates a unitary flavor-mixing matrix from fixed integer ladder-index assignments through deterministic phase assignment and unitary completion. For paired source and target states, ladder-index differences are determined and raw matrix-element magnitudes are fully determined according to mag_ij=X_opt^{∧}(abs(Delta_n_ij)/4), where X_opt=phi/pi in a disclosed embodiment. Complex phases are assigned according to a deterministic phase-gauge rule to form a complex provisional matrix, and the complex provisional matrix is unitarised to produce a CKM matrix or a PMNS matrix. In preferred embodiments, determinant-preserving and sign-preserving control are applied during phase assignment and unitary completion, and Gram-Schmidt orthonormalisation is used. The same exact magnitude rule may be used for CKM and PMNS synthesis with different fixed ladder tables.

### CROSS-REFERENCE TO RELATED APPLICATIONS

This application claims the benefit of U.S. Provisional Patent Application No. 63/794,584, filed on Apr. 25, 2025, the disclosure of which is incorporated herein by reference in its entirety.

### BACKGROUND OF THE INVENTION

The invention relates to flavor-physics computation, unitary mixing-matrix generation, neutrino-oscillation modeling, lattice electroweak simulation, and computer-implemented synthesis of CKM and PMNS matrices from discrete state-index differences.

Conventional flavor-mixing workflows treat the CKM and PMNS matrices as parameterized objects whose physically relevant mixing angles and CP phase are supplied from experimental fits. In a conventional workflow, measured angles and phase values are accepted as inputs, a numerical 3×3 matrix is constructed from those inputs, unitarity is enforced numerically, and uncertainty propagation is carried through the simulation stack. In parameter-estimation settings, the angle-and-phase variables may also increase posterior dimensionality, whereas deterministic generation from fixed ladder-index assignments can reduce posterior dimensionality, improve reproducibility across repeated executions, and provide objective acceptance of unitary outputs under a selected numerical tolerance.

That architecture differs from the technical architecture disclosed here. In the conventional architecture, the matrix is built from fitted angle parameters. In the disclosed architecture, the matrix is synthesised from fixed ladder-index assignments and a fixed mapping rule, with prescribed phase handling and unitary completion.

Accordingly, a need exists for a synthesis mechanism that can generate valid unitary flavor-mixing matrices from fixed discrete assignments and a deterministic structural rule, rather than by accepting experimentally fitted mixing angles and CP phases as primary matrix-generation inputs. A further need exists for a matrix-generation workflow in which raw matrix-element magnitudes are fully determined by ladder-index differences under a disclosed rule, and in which the final matrix is made unitary through a defined synthesis procedure.

In the disclosed approach, pairwise ladder-index differences are used to determine raw matrix-element magnitudes according to the rule mag_ij=X_opt^{∧}(abs(Delta_n_ij)/4), after which complex phases are assigned according to a prescribed deterministic phase-gauge rule and the resulting complex matrix is unitarised to produce a usable CKM or PMNS matrix. In the disclosed embodiment, X_opt=phi/pi. Recognition Science may provide upstream provenance for the disclosed constant X_opt and for the ladder-assignment framework, but Recognition Science itself is not the claimed invention.

### SUMMARY OF THE INVENTION

The invention provides methods and systems for deterministically generating a unitary flavor-mixing matrix from fixed integer ladder-index assignments through deterministic phase assignment and unitary completion. In the disclosed embodiment, a synthesis engine fully determines raw matrix-element magnitudes using mag_ij=X_opt^{∧}(abs(Delta_n_ij)/4), where X_opt=phi/pi, assigns complex phases under a deterministic phase-gauge rule that is required by the disclosed synthesis path, and unitarises the resulting complex matrix to output a CKM or PMNS matrix.

In one aspect, the invention provides a synthesis architecture having four core components: (a) index lookup, (b) raw magnitude determination, (c) deterministic phase assignment, and (d) unitary completion. These four components define the core synthesis architecture. In operation, the engine accesses fixed integer ladder assignments for paired source and target states, determines pairwise ladder-index differences Delta n_ij, maps those differences to raw matrix-element magnitudes via mag_ij=X_opt^{∧}(abs(Delta_n_ij)/4), assigns phases according to the disclosed deterministic phase-gauge rule, and applies unitary completion to generate a usable unitary matrix.

In the disclosed preferred synthesis path, determinant-preserving and sign-preserving control are applied during phase assignment and unitary completion, and Gram-Schmidt orthonormalisation is used to produce the final unitary matrix. Determinant-preserving control is a broader disclosed concept, and a determinant equal to 1 is a preferred embodiment within that broader concept. In preferred embodiments, the same exact magnitude rule is used for both CKM and PMNS synthesis, with different fixed ladder tables for the relevant state sets.

In disclosed embodiments, larger quark-sector ladder gaps than lepton-sector ladder gaps yield smaller off-diagonal quark mixing and larger lepton mixing under the same exact rule. This is a disclosed structural consequence and strategic advantage of the synthesis architecture, but does not alone define the invention.

Formal verification supports positivity, boundedness, monotonic decrease with increasing absolute Delta n, and equality of raw magnitudes for equal absolute Delta n. Benchmark evidence supports numerical unitarity and disclosed throughput characteristics. These support layers aid understanding and validation of the disclosed synthesis architecture, but are not limitations of every claim.

The invention therefore replaces angle-and-phase input workflows with a deterministic synthesis workflow driven by fixed ladder assignments, a fixed magnitude rule, a deterministic phase-gauge rule required by the disclosed synthesis path, determinant-preserving and sign-preserving control in the disclosed preferred path, and preferred Gram-Schmidt unitary completion.

### BRIEF DESCRIPTION OF THE DRAWINGS

FIG. 1 illustrates an overall flavor-mixing matrix synthesis architecture in which a synthesis engine receives a matrix-generation request, accesses fixed ladder assignments, computes ladder-index differences, determines raw magnitudes, assigns phases, unitarises the resulting complex matrix, and outputs a final unitary matrix.

FIG. 2 illustrates ladder-index tables and state pairing structure used to generate pairwise Delta n values.

FIG. 3 illustrates raw-magnitude determination from ladder-index difference according to the disclosed exact rule.

FIG. 4 illustrates deterministic phase assignment used to convert a magnitude-only matrix into a complex provisional matrix.

FIG. 5 illustrates determinant-preserving unitarisation and sign preservation in the disclosed preferred unitary-completion workflow.

FIG. 6 illustrates a CKM embodiment.

FIG. 7 illustrates a PMNS embodiment.

FIG. 8 illustrates implementation embodiments of the synthesis engine.

FIG. 9 illustrates formal-verification and validation support.

FIG. 10 illustrates downstream use embodiments.

FIG. 11 illustrates alternative and extended embodiments.

### DETAILED DESCRIPTION OF THE INVENTION

The present invention provides a computer-implemented synthesis architecture for generating a unitary flavor-mixing matrix from fixed integer ladder-index assignments without fitted mixing angles or fitted CP phases, once the applicable ladder tables and phase-gauge convention are fixed. In contrast to conventional workflows that begin by accepting experimentally fitted angular parameters and a CP phase as primary matrix-generation inputs, the disclosed architecture begins from fixed discrete assignments associated with selected states and from a fixed structural mapping rule that converts ladder-index differences into raw matrix-element magnitudes. Those raw magnitudes are then incorporated into a complex matrix through a prescribed deterministic phase-gauge rule, after which the matrix is subjected to unitary completion so that the final output is a usable unitary flavor-mixing matrix. In disclosed embodiments, the same general synthesis architecture is used to generate a CKM matrix or a PMNS matrix, with the relevant state identities and fixed ladder tables differing by matrix family while the core synthesis logic remains the same.

The invention is directed to the synthesis mechanism itself, namely the deterministic conversion of fixed discrete ladder-index structure into a unitary mixing matrix. Although the disclosed synthesis engine may be embodied in software libraries, APIs, processors, accelerators, containers, or downstream simulation workflows, those deployment forms do not define the inventive center. Rather, the inventive center is the matrix-synthesis architecture by which fixed ladder assignments are accessed, pairwise ladder-index differences are determined, raw matrix-element magnitudes are fully determined from those differences according to the disclosed rule, phases are assigned according to a deterministic phase-gauge rule required by the disclosed synthesis path, and the resulting complex matrix is unitarised to produce a final unitary matrix. As used herein, a ladder number is an integer assignment associated with a selected state used in matrix generation. A ladder-index difference is the difference Delta n_ij=n_i−n_j between a selected source-state ladder number n_i and a selected target-state ladder number n_j. Because the disclosed magnitude rule uses the absolute value of the difference, the magnitude-determination stage operates on abs(Delta_n_ij). A raw magnitude is the matrix-element magnitude produced directly from the disclosed rule before final unitary completion. A phase-gauge rule is the prescribed rule by which complex phases are assigned so that a magnitude-only matrix is converted into a complex provisional matrix suitable for subsequent unitary completion. Unitarisation is the procedure by which the complex provisional matrix is transformed into a unitary matrix whose Hermitian transpose multiplied by the matrix equals the identity matrix within selected numerical tolerance. As used herein, parameter-free means that no fitted mixing angles or fitted CP phases are supplied once the ladder-index tables and phase-gauge convention are fixed. As used herein, deterministic means that the matrix is produced by a prescribed rule rather than by tuning the matrix-generation workflow to match a selected data set. As used herein, benchmark validation refers to empirical or engineering comparison material, while formal verification refers to mathematical or definitional support for the disclosed rule or for properties of that rule. These terms are stated expressly to preserve claim discipline and to maintain the distinction between the core invention, preferred embodiments, optional embodiments, prophetic embodiments, and downstream uses.

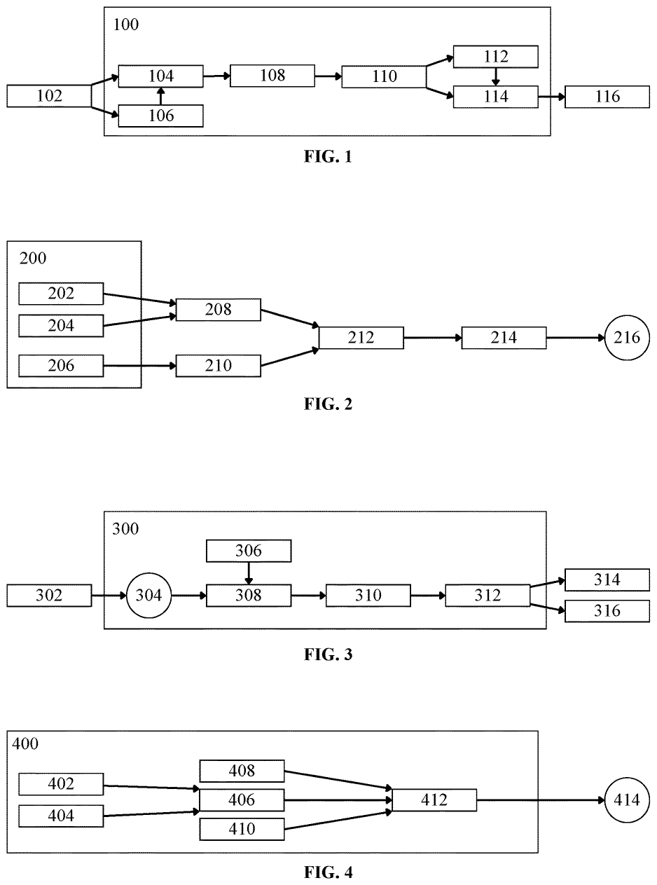

In one embodiment, and as illustrated in FIG. 1, the disclosed synthesis architecture is implemented as a synthesis system 100 having at least an index lookup module 104, a ladder-difference computation engine 108, a raw-magnitude determination engine 110, a phase-assignment module 112, and a unitarisation module 114. In use, the engine may receive an identified matrix family, such as CKM or PMNS, together with source-state identities, target-state identities, and an applicable fixed ladder table or set of fixed ladder tables. The engine may further receive, retrieve, or otherwise apply the phase-gauge convention associated with the embodiment. Using those fixed inputs, the engine retrieves the ladder number associated with each selected state, forms the relevant ladder-index differences for source-target pairings, converts those differences into raw matrix-element magnitudes under the disclosed rule, forms a complex provisional matrix by deterministic phase assignment, and completes the matrix by unitarisation. The principal output is a complex unitary flavor-mixing matrix. In disclosed embodiments, the workflow may additionally expose an intermediate raw magnitude matrix prior to phase assignment and unitarisation, an optional CP phase output extracted from the resulting unitary matrix, and one or more optional diagnostic outputs such as a unitarity-error value, an accept-or-reject indicator based on a selected numerical tolerance, a consistency indicator, or a benchmark-comparison value.

The synthesis engine may operate as an end-to-end pipeline. In one exemplary sequence, the synthesis system 100 first receives a matrix request at matrix-request input 102 identifying the matrix family to be generated. The system then accesses one or more fixed ladder tables from fixed ladder table store 106 through index lookup module 104. Source-state and target-state identities are then paired according to matrix position. For each matrix position, Delta n computation engine 108 retrieves the corresponding source-state ladder number and target-state ladder number and computes Delta n_ij. The system then applies the disclosed exact rule in raw-magnitude determination engine 110 so that the relevant absolute ladder-index difference is mapped to a raw matrix-element magnitude. After the raw magnitude matrix has been assembled, phase-assignment module 112 generates a complex provisional matrix according to the deterministic phase-gauge rule. The system then performs unitary completion in unitarisation module 114, preferably with determinant-preserving and sign-preserving control in the disclosed preferred synthesis path, so that final unitary matrix output 116 is a unitary matrix suitable for direct use as a CKM matrix or PMNS matrix. This sequence is deterministic in the sense that repeated execution on the same fixed inputs yields the same unitary flavor-mixing matrix subject to normal machine precision and the selected conventions of the embodiment.

The input data model is based on fixed discrete state assignments rather than fitted angle inputs. In a preferred CKM embodiment, the source-state set is the set of up-type quark states and the target-state set is the set of down-type quark states. In a preferred PMNS embodiment, the source-state set is the set of charged-lepton flavor states and the target-state set is the set of neutrino mass-eigenstate states. The state sets are associated with fixed integer ladder assignments stored in one or more lookup structures. As illustrated in FIG. 2, ladder-table structure 200 may include quark ladder table 202, charged-lepton ladder table 204, and neutrino ladder table 206. Such lookup structures may be embodied as in-memory tables, persistent storage records, hard-coded arrays, firmware tables, or other machine-readable structures capable of reliably returning the predetermined ladder number associated with a selected state. The invention does not require that the lookup structure take any particular software form, provided that the disclosed synthesis engine can access fixed integer assignments for the states involved in matrix generation.

In the disclosed quark embodiment, the fixed ladder assignments are u=0, d=1, c=11, s=10, t=30, and b=31. In the disclosed charged-lepton embodiment, the fixed ladder assignments are e=0, mu=9, and tau=11. In the disclosed neutrino mass-eigenstate embodiment, the fixed ladder assignments are nu_1=3, nu_2=10, and nu_3=23. These disclosed tables are preferred fixed assignments for the illustrated embodiments and provide the basis for the pairwise ladder-index differences used in the disclosed matrix synthesis workflow. Each matrix element is formed by pairing a selected source state with a selected target state. As illustrated in FIG. 2, source-state selector 208 and target-state selector 210 provide state identities to state pairing map 212, which yields Delta n output set 214. Once the pair is chosen, the ladder numbers associated with those states are retrieved and the corresponding Delta n_ij value is computed, and because the disclosed raw magnitude rule uses the absolute value of the difference, the magnitude stage receives abs(Delta_n_ij) through absolute-value stage 216. Equal absolute Delta n values therefore correspond to equal raw magnitudes, and larger absolute Delta n values correspond to smaller raw magnitudes under the disclosed rule. These ordering relations are part of the disclosed structure of the synthesis architecture and are not merely optional observations or downstream interpretations.

The raw magnitude determination stage is a load-bearing part of the invention. As illustrated in FIG. 3, raw-magnitude engine 300 receives Delta n input 302, applies absolute-value stage 304, receives X_opt from X_opt store 306, forms the applicable exponent at exponent stage 308, and applies the disclosed power-law mapping at power-evaluation stage 310 to produce raw-magnitude output 312. In the disclosed embodiment, the exact rule is mag_ij=X_opt^{∧}(abs(Delta_n_ij)/4), with X_opt=phi/pi. Under this rule, the raw matrix-element magnitude is fully determined by the ladder-index difference. Thus, once the relevant state pair is known and the corresponding absolute ladder-index difference has been formed, the raw magnitude is fixed by the disclosed rule rather than by fitting, searching, or free-form adjustment. The exponent 1/4 is not arbitrary and arises from the disclosed fourth-root J-cost ratio between ladder levels.

The raw magnitude stage may be understood as operating on a sequence of increasingly separated ladder assignments. For relatively small absolute Delta n, the rule yields relatively larger raw magnitudes. For larger absolute Delta n, the rule yields correspondingly smaller raw magnitudes. By way of representative illustration, absolute Delta n=1 yields a relatively large raw value, approximately X_opt^{∧}0.25 about 0.847, absolute Delta n=10 yields a smaller raw value, approximately X_opt^{∧}2.50 about 0.190, absolute Delta n=20 yields a still smaller raw value, approximately X_opt^{∧}5.00 about 0.036, and absolute Delta n=31 yields a correspondingly suppressed raw value, approximately X_opt^{∧}7.75 about 0.0058. In the disclosed CKM embodiment, this produces a raw structure with diagonal dominance and comparatively smaller off-diagonal entries, such that the raw hierarchy follows the expected ordering V_ud magnitude greater than V_us magnitude greater than V_ub magnitude, with corresponding suppression across larger quark-sector ladder separations. In the disclosed PMNS embodiment, smaller lepton-sector ladder gaps yield relatively larger off-diagonal raw weights than in the CKM embodiment under the same exact rule. The raw magnitudes are positive, bounded, reproducible from the same fixed inputs, equal for equal absolute Delta n values, and monotonically decreasing as absolute Delta n increases, as reflected for example by monotonic-order indicator 314 and equal-Delta n equality indicator 316 in FIG. 3. Those properties are not added by later validation language but arise from the disclosed structure of the mapping rule itself.

For practical operation, the synthesis engine may compute the raw magnitudes for all matrix positions and assemble them into a magnitude-only matrix indexed by source-state and target-state position. This magnitude-only matrix may be retained as an intermediate computational artifact, stored for audit purposes, output to a user or process, or passed directly into the phase-assignment stage. The magnitude-only matrix is a disclosed output of the raw-magnitude stage and a fallback output of the overall synthesis workflow, but it is not the preferred final output of the invention because the invention is directed to the generation of a unitary flavor-mixing matrix. The magnitude-only matrix is therefore best understood as an intermediate product of the core synthesis workflow. It may nevertheless be useful for analysis, debugging, validation, benchmarking, or comparison of raw structural consequences before phases are assigned and before unitary completion is applied.

The invention does not require that the raw magnitude matrix already be unitary. To the contrary, the disclosure expressly contemplates that the magnitude-only matrix is an intermediate stage that precedes complex-matrix formation and unitarisation. After assembly of the magnitude-only matrix, the synthesis workflow proceeds by assigning phases according to the prescribed deterministic phase-gauge rule so that the magnitude-only matrix is converted into a complex provisional matrix. That phase-assigned matrix is then subjected to unitary completion so that the output matrix satisfies the desired unitary condition. By structuring the workflow in this way, the invention preserves a clear distinction between raw magnitude determination, complex provisional assembly, and final unitarisation, while still allowing each of those stages to be implemented within a single integrated synthesis engine.

After the raw magnitude matrix has been formed, and as illustrated in FIG. 4, phase-assignment subsystem 400 receives raw magnitude matrix 402 and assigns complex phases to produce complex provisional matrix 412. This phase-assignment stage is governed by a deterministic phase-gauge rule. The phase-gauge rule is required by the disclosed synthesis path and is not a fitted parameter search. Stated differently, the synthesis engine does not search over free phase inputs in order to tune the resulting matrix to a selected benchmark. Instead, the phase structure is imposed according to a prescribed rule associated with the embodiment. In a presently preferred concrete implementation, fixed first-row phase set 404 is set to zero and remaining-phase assignment module 406 assigns the remaining phases deterministically under selected determinant-control module 408 and sign-convention module 410 conventions, thereby producing complex provisional matrix 412, and optional CP-phase extractor 414 may in relevant embodiments extract a CP-phase output from the resulting unitary matrix. This first-row-zero treatment is a preferred embodiment of the broader deterministic phase-gauge rule and should not be read as limiting the broader concept of prescribed deterministic phase assignment to only that one expression unless specifically claimed that way.

The deterministic phase-assignment stage may be implemented so that reproducibility is preserved across repeated executions on identical fixed inputs. Thus, when the same matrix family, state identities, ladder tables, and phase-gauge convention are supplied, the same complex provisional matrix is produced subject to normal computational precision. If more than one formally gauge-equivalent assignment could be used, the synthesis engine selects a predetermined phase assignment that satisfies the applicable determinant and sign conventions, for example by applying a fixed ordering convention associated with the embodiment, and if determinant and sign constraints compete during assignment, a predetermined ordering rule is applied so that the synthesis path remains fixed rather than discretionary. In relevant embodiments, the CP phase delta may later be extracted from the resulting unitary matrix under a selected standard parametrisation, so that CP phase delta is an output of the synthesis procedure, not a fitted input.

Once the complex provisional matrix has been formed, the synthesis engine performs unitary completion. The invention outputs a unitary matrix and therefore includes a unitary-completion stage as part of the core synthesis architecture. In the disclosed preferred synthesis path, determinant-preserving and sign-preserving control are applied during phase assignment and unitary completion. Determinant-preserving control is a broader disclosed concept of the workflow, while a determinant equal to 1 is a preferred embodiment within that broader concept. Likewise, sign-preserving control is disclosed to maintain selected sign conventions through the completion process, and in preferred embodiments the diagonal entries are maintained according to a positive-real diagonal convention. These controls are part of the disclosed preferred path by which the engine moves from a complex provisional matrix to a final unitary matrix suitable for use as a CKM matrix or PMNS matrix.

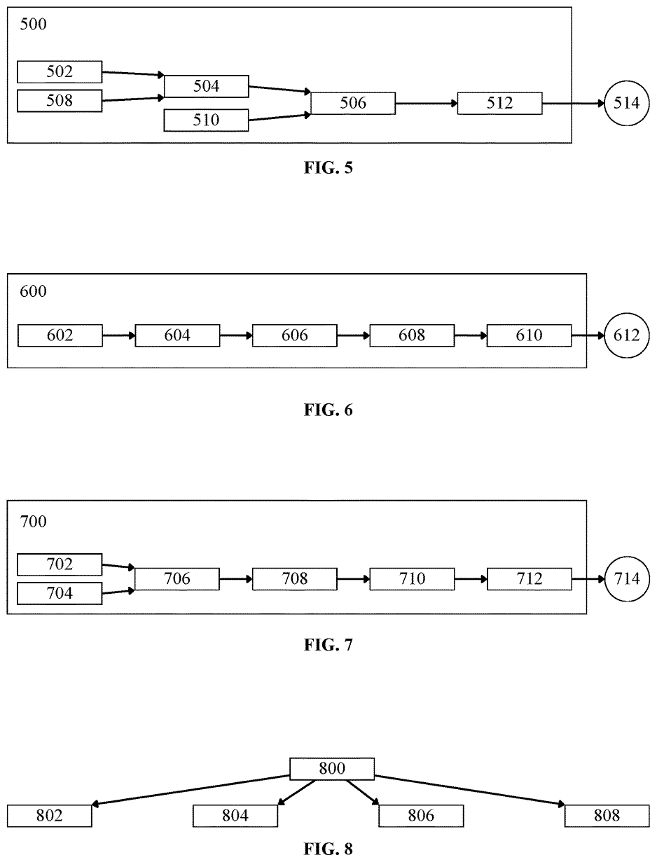

In a presently preferred embodiment, and as illustrated in FIG. 5, Gram-Schmidt orthonormalisation is used as the disclosed preferred unitarisation method in unitarisation subsystem 500. In one implementation, first-column normalisation stage 502 takes a first column of the complex provisional matrix and normalises it. Second-column orthogonalisation stage 504 then orthogonalises a second column against the first column and normalises it. Third-column orthogonalisation stage 506 then orthogonalises a third column against the first and second columns and normalises it. This sequence yields an orthonormal column structure from which a unitary matrix is obtained. During or after those operations, sign-preservation control 508 may be applied. In preferred embodiments, determinant-preservation control 510 is also applied so that final unitary matrix 512 satisfies the selected determinant convention, including a determinant equal to 1 in the preferred embodiment, and unitarity-error evaluator 514 may provide a corresponding error metric. Acceptance criteria for the final output may include satisfaction of the condition that the Hermitian transpose of the matrix multiplied by the matrix equals the identity matrix within a selected numerical tolerance, wherein the selected numerical tolerance may be predetermined in a configuration record, stored in memory, or provided as a request parameter associated with the matrix-generation request and may vary by precision mode, preservation of selected determinant and sign conventions, reproducibility from identical fixed inputs, and preservation of the selected positive-real diagonal convention in embodiments using that convention. Although other language may be used in subordinate embodiments to describe unitary completion, Gram-Schmidt orthonormalisation is the disclosed preferred unitarisation method and remains the preferred implementation unless specifically displaced by later-claimed alternative material.

The CKM embodiment may now be described in greater detail. As illustrated in FIG. 6, CKM embodiment 600 generates a CKM matrix using quark ladder assignment block 602. In that embodiment, the source-state set is the set of up-type quark states and the target-state set is the set of down-type quark states. Using the disclosed fixed quark ladder assignments u=0, d=1, c=11, s=10, t=30, and b=31, the engine forms the pairwise differences for each matrix position. Thus, for the element V_ud, the relevant absolute ladder-index difference is 1. For V_us, the absolute ladder-index difference is 10. For V_ub, the absolute ladder-index difference is 31. For V_cd, the absolute ladder-index difference is 10. For V_cs, the absolute ladder-index difference is 1. For V_cb, the absolute ladder-index difference is 20. For V_td, the absolute ladder-index difference is 29. For V_ts, the absolute ladder-index difference is 20. For V_tb, the absolute ladder-index difference is 1.

These CKM Delta n values are then supplied to the disclosed exact magnitude rule so that the raw CKM magnitudes are fully determined directly from the rule rather than from fitted angle inputs, with each element magnitude following directly from the corresponding absolute ladder-index difference under the disclosed power-law mapping. Because the raw matrix-element magnitude is fully determined by the ladder-index difference, the CKM raw structure is fixed once the state pairing and the fixed quark ladder assignments are fixed. In the disclosed quark-sector embodiment, the ladder-gap structure yields diagonal dominance. The diagonal-favored terms V_ud, V_cs, and V_tb each correspond to absolute Delta n=1 and therefore each receive comparatively larger raw magnitudes. By contrast, more strongly separated pairings such as V_ub with absolute Delta n=31 and V_td with absolute Delta n=29 receive substantially smaller raw magnitudes under the same exact rule. Intermediate off-diagonal terms such as V_us and V_cd with absolute Delta n=10, and V_cb and V_ts with absolute Delta n=20, fall between those extremes according to the disclosed monotonic relation. Accordingly, the disclosed quark-sector ladder-gap structure contributes to smaller off-diagonal quark mixing under the same exact magnitude rule used elsewhere in the disclosure.

The preferred CKM synthesis workflow therefore proceeds, as illustrated in FIG. 6, by generating CKM Delta n map 604 from quark ladder assignment block 602, computing CKM raw-magnitude block 606 from the exact Delta n-based magnitude rule, assigning phases in phase-assignment block 608, applying Gram-Schmidt orthonormalisation as the disclosed preferred unitarisation method, preserving the selected sign convention and the positive-real diagonal convention in the preferred embodiment, and producing unitarised CKM output 610, with benchmark comparison block 612 providing validation support in disclosed embodiments. The resulting matrix is a complex unitary CKM matrix. In disclosed embodiments, the engine may also expose the intermediate raw CKM magnitude matrix as a fallback output prior to phase assignment and unitarisation, may expose an optional unitarity metric, and may expose a CP phase output in embodiments configured to do so. The principal output, however, is the final unitary CKM matrix.

A benchmark unitarised CKM magnitude matrix produced by the disclosed synthesis path may be represented in magnitude form as approximately V_ud magnitude 0.976, V_us magnitude 0.219, V_ub magnitude 0.004, V_cd magnitude 0.219, V_cs magnitude 0.975, V_cb magnitude 0.043, V_td magnitude 0.009, V_ts magnitude 0.042, and V_tb magnitude 0.999. This benchmark output reflects the disclosed structural consequence that larger quark-sector ladder gaps suppress off-diagonal raw magnitudes and that the subsequent deterministic phase assignment and preferred unitarisation workflow produce a final unitary matrix exhibiting the expected CKM hierarchy. Comparisons with PDG values may be used as benchmark validation material only, including element-by-element magnitude comparison and ratio-based comparison of generated CKM magnitudes against reference values. Such benchmark comparison supports the disclosed embodiment and its operation, but agreement with measured values is treated as benchmark validation and not as a required limitation of the invention. The disclosed CKM embodiment therefore remains defined by the deterministic synthesis workflow itself, not by any requirement that the broadest claims be tied to a specific benchmark table or error threshold. The PMNS embodiment may likewise be described in greater detail. As illustrated in FIG. 7, PMNS embodiment 700 generates a PMNS matrix using charged-lepton ladder block 702 and neutrino ladder block 704. In that embodiment, the source-state set is the set of charged-lepton flavor states and the target-state set is the set of neutrino mass-eigenstate states. Using the disclosed fixed charged-lepton ladder assignments e=0, mu=9, and tau=11, together with the disclosed fixed neutrino ladder assignments nu_1=3, nu_2=10, and nu_3=23, the engine forms the pairwise ladder-index differences for each PMNS matrix position. Thus, for U_e1, the relevant absolute ladder-index difference is 3. For U_e2, the absolute ladder-index difference is 10. For U_e3, the absolute ladder-index difference is 23. For U_mu1, the absolute ladder-index difference is 6. For U_mu2, the absolute ladder-index difference is 1. For U_mu3, the absolute ladder-index difference is 14. For U_tau1, the absolute ladder-index difference is 8. For U_tau2, the absolute ladder-index difference is 1. For U_tau3, the absolute ladder-index difference is 12. These PMNS Delta n values are then supplied to the same disclosed exact rule so that the raw PMNS magnitudes are fully determined directly from the same magnitude law used in the CKM embodiment, but with different fixed state tables, with each element magnitude following directly from the corresponding absolute ladder-index difference under the disclosed power-law mapping. The disclosed PMNS embodiment therefore shows that the synthesis engine can generate a second matrix family without changing the underlying rule that maps ladder-index differences to raw matrix-element magnitudes. Because the charged-lepton and neutrino ladder assignments in the disclosed embodiment yield smaller relevant ladder gaps than those appearing in the disclosed quark-sector embodiment, the resulting PMNS raw structure includes relatively larger off-diagonal raw weights. Stated differently, the disclosed lepton-sector ladder-gap structure contributes to larger mixing under the same exact rule used elsewhere in the disclosure, thereby preserving a shared-engine architecture in which CKM and PMNS synthesis differ by fixed ladder tables rather than by different magnitude laws. This is a structural consequence of the disclosed fixed assignments and the disclosed mapping rule, and it is a strategic advantage of the shared synthesis architecture because the same exact rule accounts for smaller quark mixing and larger lepton mixing through differences in fixed ladder structure rather than through separate angle-fit workflows.

The preferred PMNS synthesis workflow proceeds, as illustrated in FIG. 7, by generating PMNS Delta n map 706 from charged-lepton ladder block 702 and neutrino ladder block 704, computing PMNS raw-magnitude block 708, assigning phases in phase-assignment block 710, applying Gram-Schmidt orthonormalisation as the disclosed preferred unitarisation method, preserving selected determinant and sign conventions, and producing unitarised PMNS output 712, with validation comparison block 714 providing benchmark support in disclosed embodiments. As with the CKM embodiment, the synthesis engine may expose multiple outputs in hierarchical form. The principal output is a complex unitary PMNS matrix. Additional disclosed outputs may include an intermediate raw magnitude matrix prior to phase assignment and unitarisation, an optional CP phase output in embodiments exposing it, and an optional unitarity-error metric. The magnitude-only matrix remains an intermediate or fallback output and not the preferred final output, because the invention is directed to a synthesis architecture for generating a usable unitary flavor-mixing matrix.

A benchmark unitarised PMNS magnitude matrix produced by the disclosed synthesis path may be represented in magnitude form as approximately row 1 [0.801, 0.583, 0.136], row 2 [0.487, 0.501, 0.716], and row 3 [0.349, 0.639, 0.685]. This benchmark output is consistent with qualitative large-angle neutrino-mixing structure in the PMNS sector. Comparisons against large-angle mixing expectations, and in some validation contexts against external fit ranges or angle-band data, including external fit-band comparison for solar, atmospheric, and reactor-angle structure, are treated as benchmark validation support only. Such comparison material illustrates the performance or usefulness of the disclosed embodiment, including qualitative comparison to large-angle structure and optional comparison to external fit-band targets, but is not a required limitation of the invention itself. The PMNS embodiment is therefore defined by the deterministic synthesis workflow and by the disclosed fixed ladder structures and exact rule, rather than by any requirement that the claims be limited to a particular external benchmark table.

The disclosure further provides a shared-engine architecture covering both CKM and PMNS synthesis. In preferred embodiments, the same synthesis architecture is used to generate either matrix family. The shared architecture may reuse the ladder-lookup stage, the Delta n computation stage, the exact magnitude rule, the deterministic phase-assignment stage, and the unitary-completion stage. The principal difference between matrix families lies in the selected state tables and the associated pairings, not in the core computational rule. Reuse of the same exact rule across both CKM and PMNS synthesis is a strategically important breadth-preserving feature of the disclosure because it supports claims directed to a common matrix-synthesis engine while still supporting narrower CKM-only or PMNS-only embodiments. At the same time, the disclosure does not exclude single-sector embodiments merely because the preferred embodiment covers both matrix families. A synthesis engine configured only for CKM generation remains within the disclosure, and a synthesis engine configured only for PMNS generation likewise remains within the disclosure.

In system form, and as illustrated in FIG. 8, the invention may be implemented using implementation architecture 800 including one or more processors executing instructions that perform the disclosed synthesis workflow. The engine may be embodied as application software, a compiled executable, a library, a callable service, a firmware routine, a dedicated appliance workflow, or another machine-implemented arrangement capable of executing the disclosed sequence of ladder lookup, Delta n determination, raw magnitude determination, deterministic phase assignment, and unitary completion, and may in some embodiments be exposed through language bindings, library interfaces, network services, packaged deployment artifacts, C or Fortran bindings, Python-accessible interfaces, REST services, or gRPC services. In some embodiments, the engine may accept repeated matrix requests and therefore may be used in a batch-generation architecture for repeated synthesis of one or more matrices under a fixed convention. Such repeated synthesis may be useful for repeated evaluation, validation, simulation input generation, or consistency testing. In further embodiments, accelerator implementation 804 may be used, including GPU embodiments, FPGA embodiments, or other specialized hardware capable of accelerating the disclosed synthesis pipeline or repeated execution of that pipeline. In still further embodiments, container embodiment 806 may package the synthesis engine or its instructions, and in yet further embodiments ROM or embedded-storage embodiment 808 may store one or more generated matrices or synthesis instructions, while processor implementation 802 supports processor-based execution.

These processor, accelerator, storage, and packaging embodiments are implementation embodiments of the disclosed synthesis engine and are not the core inventive mechanism. They are described to support enablement, implementation flexibility, and claim-format variation, including method claims, system claims, medium claims, and narrower hardware-oriented fallback positions. Accordingly, details such as specific software bindings, REST exposure, gRPC exposure, container sizing, RAM usage, latency metrics, accelerator productisation details, or packaging conventions may be disclosed in subordinate form where useful, but such matters remain secondary to the core matrix-synthesis mechanism.

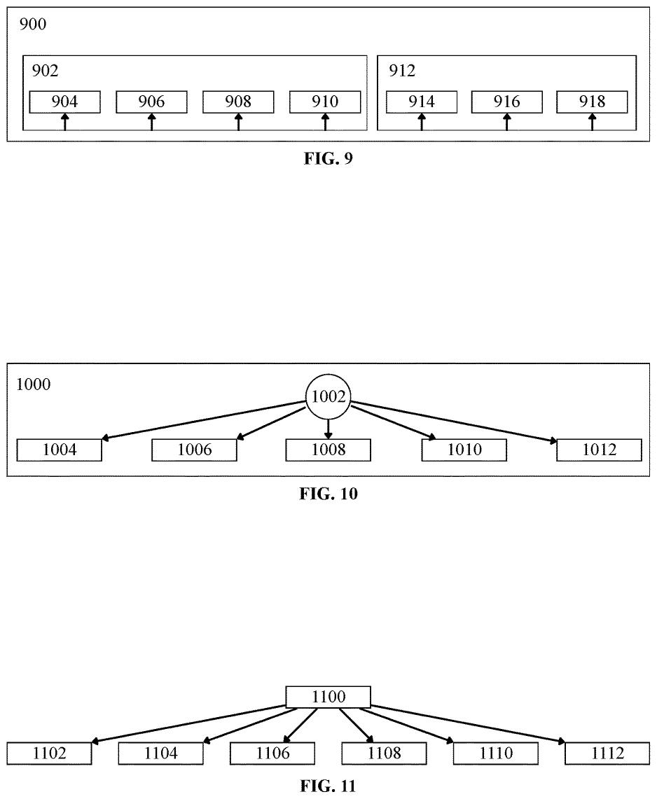

The disclosure also provides, as illustrated in FIG. 9, support framework 900 for the determinacy of the synthesis rule and for the ordering relations built into the rule. In disclosed formalisation, formal-support block 902 supports properties such as positivity property 904, boundedness property 906, monotonic-order property 908, equal-Delta n equality property 910, and parameter-free operation at the mathematical or definitional level, while benchmark-support block 912 may support unitarity benchmark block 914, throughput benchmark block 916, and cross-platform consistency block 918. In plain language, positivity means that each raw magnitude is greater than 0. Boundedness means that each raw magnitude is less than or equal to 1. Monotonic decrease means that larger absolute Delta n yields smaller raw magnitude. Equal-Delta n equality means that equal absolute Delta n yields equal raw magnitude. Parameter-free means that the disclosed rule operates without fitted mixing-angle or fitted CP-phase inputs once the ladder tables and phase-gauge convention are fixed, thereby reducing posterior dimensionality relative to angle-and-phase input workflows and improving reproducibility across repeated executions on identical fixed inputs. This material is included to reinforce the fact that the disclosed mapping rule is deterministic and structurally constrained, and to support positivity, boundedness, monotonic ordering, equal-Delta n equality, and parameter-free operation as formal properties of the disclosed synthesis rule. At the same time, the disclosure does not require implementation in Lean or in any other specific proof assistant unless such implementation is later and intentionally claimed.

The disclosure additionally contemplates validation and acceptance criteria for working embodiments. At the mathematical and formal level, a working embodiment may be expected to reproduce the ordering, positivity, boundedness, and repeatability characteristics of the disclosed rule. At the numerical output level, a working embodiment may be expected to compute a unitarity-error value based on deviation of the Hermitian transpose of the matrix multiplied by the matrix from the identity matrix, wherein the unitarity-error value may be computed using a Frobenius norm, a maximum-entry norm, or a spectral norm, and to accept the final matrix when the unitarity-error value does not exceed the selected numerical tolerance after the disclosed completion process has been applied. In benchmark embodiments, the unitarity error may be less than 10^{∧}-14 in double precision, and the resulting matrix may be accepted or rejected according to whether the unitarity-error value satisfies the selected numerical tolerance. In validation contexts, generated CKM magnitudes may be compared to PDG values and generated PMNS magnitudes may be compared to qualitative large-angle structure and, where useful, to external fit ranges. Cross-platform validation may also be performed so that outputs generated on different processor, GPU, FPGA, or related implementations can be compared for consistency. Throughput validation may likewise be reported for selected implementations, including processor, GPU, FPGA, container, latency, memory-footprint, container-size, or related engineering benchmarks for disclosed embodiments where such data is available. However, such validation and benchmark material demonstrates or benchmarks disclosed embodiments and should not be mistaken for a requirement that every claim achieve every listed benchmark value. Acceptance criteria for a working embodiment may therefore include reproducible generation of raw magnitudes from fixed inputs, reproducible generation of a complex provisional matrix from fixed inputs, production of a final unitary matrix through the disclosed synthesis workflow, preservation of selected determinant and sign conventions, satisfaction of the unitarity condition within selected numerical tolerance, and consistency across repeated executions using identical fixed inputs.

The disclosure further includes worked examples illustrating the operation of the synthesis engine. In a first example, the engine receives a request to generate a CKM matrix. The identified matrix family is CKM, the fixed quark ladder assignments are retrieved, and the disclosed phase-gauge convention for the embodiment is applied. The engine pairs each up-type quark state with each down-type quark state, determines the corresponding CKM Delta n values, computes the raw magnitudes according to mag_ij=X_opt^{∧}(abs(Delta_n_ij)/4), assembles the raw magnitude matrix, assigns phases according to the deterministic phase-gauge rule, and unitarises the resulting complex provisional matrix through the disclosed preferred Gram-Schmidt workflow while preserving selected determinant and sign conventions. The resulting output may include a complex CKM matrix as the principal output, an optional magnitude-only CKM matrix as an intermediate or fallback output, and an optional unitarity metric. In benchmark use, the resulting CKM magnitudes may be compared against PDG values, but that comparison remains benchmark validation material and not the defining feature of the invention.

In a second example, the engine receives a request to generate a PMNS matrix. The identified matrix family is PMNS, the fixed charged-lepton ladder assignments and fixed neutrino mass-eigenstate ladder assignments are retrieved, and the disclosed phase-gauge convention for the embodiment is applied. The engine pairs each charged-lepton flavor state with each neutrino mass-eigenstate state, determines the corresponding PMNS Delta n values, computes the raw magnitudes using mag_ij=X_opt^{∧}(abs(Delta_n_ij)/4), assembles the raw magnitude matrix, assigns phases according to the deterministic phase-gauge rule, and unitarises the resulting complex provisional matrix through the disclosed preferred Gram-Schmidt workflow while preserving selected determinant and sign conventions. The resulting output may include a complex PMNS matrix as the principal output, an optional magnitude-only PMNS matrix as an intermediate or fallback output, and an optional unitarity metric. In validation use, the resulting PMNS matrix may be compared against qualitative large-angle neutrino-mixing structure and, in some contexts, against external fit ranges, but again such comparison remains validation material rather than a mandatory limitation of the invention.

In a third example, the synthesis engine is used in a batch-generation embodiment. In that embodiment, repeated matrix requests are supplied to the engine, optionally under a common fixed convention and common ladder-table configuration. The engine repeatedly executes the disclosed synthesis pipeline, including ladder lookup, Delta n computation, exact raw magnitude determination, deterministic phase assignment, and unitary completion. Such repeated execution may be carried out on a processor-based system, a GPU embodiment, an FPGA embodiment, or another implementation embodiment capable of accelerating or parallelizing the disclosed workflow. Outputs may include multiple generated matrices, an optional throughput metric, an optional unitarity-consistency metric, and cross-platform comparison data where different implementation embodiments are used. This batch-generation example is a demonstrated or benchmarked implementation embodiment of the disclosed synthesis engine and remains subordinate to the core inventive mechanism.

In a fourth example, a CKM matrix generated by the disclosed synthesis engine is supplied to a downstream lattice weak-decay workflow. In that example, the engine first synthesises the CKM matrix according to the disclosed deterministic synthesis path. The resulting matrix is then provided as deterministic input to a downstream weak-decay analysis or related lattice electroweak simulation. The output of this example is therefore a deterministic CKM input for the downstream workflow. Any comparison between downstream results and external reference values is treated as benchmark use material only. This example illustrates a downstream use of the disclosed synthesis engine and not the identity of the invention itself.

In a fifth example, a PMNS matrix generated by the disclosed synthesis engine is supplied to a downstream neutrino-oscillation workflow. In that example, the engine first synthesises the PMNS matrix according to the disclosed deterministic synthesis path. The resulting matrix is then provided as deterministic input to an oscillation-analysis workflow, beam-study workflow, or related neutrino-modeling process. The output of this example is therefore a deterministic PMNS input for the downstream workflow. Any downstream comparison with experimental spectra, fit regions, or forecasting targets is treated as validation or benchmark use material only. This example likewise illustrates a downstream use of the disclosed synthesis engine and not the core inventive mechanism. In the examples just described, the CKM and PMNS generation examples are core demonstrated or benchmarked synthesis embodiments, the batch-generation example is a demonstrated or benchmarked implementation embodiment, and the lattice and oscillation examples are downstream use examples. Prophetic or future-facing subject matter is described separately and is not represented as demonstrated reduction to practice unless expressly stated otherwise.

The disclosure also preserves, as illustrated in FIG. 11, extended-embodiment framework 1100 including alternative and extended embodiments that are not required for the core invention but may be pursued where appropriate support and strategy exist. In one alternative embodiment, fourth-generation extension 1102 may extend the synthesis engine to a 4×4 matrix framework, such as by introducing a fourth-generation state set with corresponding fixed ladder assignments. In another alternative embodiment, Majorana-phase extension 1104 may adapt the synthesis engine for a Majorana-phase framework in which additional phase structure is included for a neutrino-related embodiment. In another embodiment, CP-output extension 1106 may expose CP-phase output more explicitly as a dedicated output product of the synthesis procedure. In a further embodiment, running-matrix extension 1108 may adapt the synthesis architecture to a running-matrix or scale-dependent framework. In yet another embodiment, BSM mixing extension 1110 may extend the same deterministic ladder-based synthesis logic to beyond-Standard-Model mixing matrices. In still further embodiments, embedded-storage extension 1112 may store generated matrices or instructions for generating such matrices. These embodiments are disclosed as alternative or extended embodiments and should not be read to redefine the core invention, which remains the deterministic synthesis of a unitary flavor-mixing matrix from fixed ladder assignments, exact Delta n-based magnitude determination, prescribed deterministic phase assignment, and unitary completion.

The disclosure additionally identifies downstream uses of the disclosed synthesis engine. As illustrated in FIG. 10, downstream-use framework 1000 may receive shared matrix output 1002 and supply it as an upstream deterministic matrix input for neutrino-oscillation workflow 1004, lattice weak-decay workflow 1006, collider workflow 1008, beam-optimisation workflow 1010, or cross-code standardisation workflow 1012. Such uses may support dependent claims, continuation practice, or implementation-specific embodiments, but they do not redefine the core invention.

The disclosure further preserves subject matter that may later be pursued in continuation practice if additional support or strategic reason develops. Such subject matter may include CP-phase prediction claims, running-matrix claims, beyond-Standard-Model sector claims, dedicated accelerator or ASIC claims, broader platform-standardisation claims, and related future-facing subject matter. By disclosing such material in subordinate form, the present specification preserves flexibility for later practice without elevating those subjects into the core definition of the presently claimed invention.

Throughout this disclosure, strategically important distinctions are maintained among core features, preferred features, optional implementation material, prophetic extensions, and downstream uses. The core invention includes fixed integer ladder assignments for paired source and target states, determination of pairwise ladder-index differences, full determination of raw matrix-element magnitudes from those differences according to the load-bearing rule mag_ij=X_opt^{∧}(abs(Delta_n_ij)/4), X_opt=phi/pi in the disclosed embodiment, prescribed deterministic phase assignment according to the disclosed phase-gauge rule, determinant-preserving and sign-preserving control in the disclosed preferred synthesis path, unitary completion of the resulting complex matrix, and output of a usable CKM or PMNS matrix without fitted mixing angles or fitted CP phases once the ladder tables and phase-gauge convention are fixed. Preferred but not universally required features include the disclosed quark ladder assignments, the disclosed charged-lepton and neutrino ladder assignments, use of the same core engine for both CKM and PMNS synthesis, first-row phase values fixed to zero as a preferred concrete embodiment, determinant and sign conventions used in the disclosed preferred path, a determinant equal to 1 in the preferred embodiment, Gram-Schmidt orthonormalisation as the disclosed preferred unitarisation method, sign preservation and positive-real diagonal convention, extraction of CP phase delta from the synthesised unitary matrix in relevant embodiments, and output of an intermediate raw magnitude matrix prior to phase assignment and unitarisation. Optional subordinate material includes software bindings, REST or gRPC exposure, containerisation, GPU deployment, FPGA deployment, ROM or embedded storage, specific response formats, and benchmark-performance packaging details, while prophetic material includes 4×4 extensions, Majorana-phase extensions, scale-dependent running mixing, beyond-Standard-Model mixing matrices, and broader CP-phase prediction claims tied to future measurements.

The figures may be understood consistently with the foregoing narrative. In one representative embodiment, an overall synthesis system receives a matrix request, accesses fixed ladder assignments through a lookup function, computes Delta n values, determines raw magnitudes, assigns phases, unitarises the resulting complex matrix, and outputs a final unitary matrix. In another representative embodiment, ladder-table structures and state-pairing arrangements are used to generate pairwise Delta n values and corresponding absolute-value inputs to the disclosed magnitude rule. In another representative embodiment, a raw-magnitude engine applies the exact rule to generate magnitudes exhibiting the disclosed monotonic ordering and equal-Delta n equality properties. In another representative embodiment, a phase-assignment subsystem converts a magnitude-only matrix into a complex provisional matrix under the disclosed deterministic phase-gauge rule with selected determinant and sign conventions. In another representative embodiment, a unitarisation subsystem implements the disclosed preferred Gram-Schmidt workflow together with determinant-preserving and sign-preserving control to produce a final unitary matrix. Additional representative embodiments depict the CKM and PMNS sector examples, subordinate implementation architectures, formal-support and benchmark-support frameworks, downstream use workflows, and alternative or extended embodiments. These figure-related embodiments support the disclosure of the synthesis engine and its preferred and subordinate forms, but do not alter the core identity of the invention as described above.

Accordingly, the present disclosure provides a deterministic synthesis architecture that replaces conventional angle-and-phase input workflows with a workflow driven by fixed ladder assignments, exact Delta n-based raw magnitude determination, a deterministic phase-gauge rule required by the disclosed synthesis path, and unitary completion. The raw matrix-element magnitude is fully determined by the ladder-index difference. Larger absolute Delta n produces smaller raw magnitude. Equal absolute Delta n produces equal raw magnitude. The same exact rule is used for CKM and PMNS in the preferred shared-engine embodiment. In relevant embodiments, CP phase delta is an output of the synthesis procedure, not a fitted input. Agreement with measured values is treated as benchmark validation where such comparison is discussed. Gram-Schmidt orthonormalisation is the disclosed preferred unitarisation method. Determinant-preserving and sign-preserving control are part of the disclosed preferred phase and unitary workflow. Determinant-preserving control is the broader disclosed concept, and a determinant equal to 1 is a preferred embodiment. The exponent 1/4 is not arbitrary and arises from the disclosed fourth-root J-cost ratio between ladder levels. For all of these reasons, the invention provides a distinct and technically different architecture for generating unitary flavor-mixing matrices from fixed discrete assignments rather than from fitted mixing-angle and CP-phase inputs.

1. A computer-implemented method for generating a unitary flavor-mixing matrix, the method comprising: accessing fixed integer ladder assignments for a plurality of source states and a plurality of target states; pairing the source states and the target states to define matrix positions; determining, for each matrix position, a ladder-index difference between a ladder assignment of a corresponding source state and a ladder assignment of a corresponding target state; determining, for each matrix position, a raw matrix-element magnitude according to mag_ij=X_opt^{∧}(abs(Delta_n_ij)/4); assigning complex phases to the raw matrix-element magnitudes according to a deterministic phase-gauge rule to produce a complex provisional matrix; and unitarising the complex provisional matrix to produce a unitary flavor-mixing matrix.

2. The method of claim 1, wherein X_opt=phi/pi.

3. The method of claim 1, wherein the deterministic phase-gauge rule sets first-row phases to zero, applies a predetermined convention to resolve multiple allowable phase assignments, and is not a fitted parameter search.

4. The method of claim 1, wherein the unitarising comprises applying Gram-Schmidt orthonormalisation.

5. The method of claim 1, wherein determinant-preserving control is applied during phase assignment, unitary completion, or both.

6. The method of claim 5, wherein the unitary flavor-mixing matrix has a determinant equal to 1.

7. The method of claim 1, wherein sign-preserving control is applied during unitary completion.

8. The method of claim 7, wherein a positive-real diagonal convention is preserved in the unitary flavor-mixing matrix.

9. The method of claim 1, wherein the unitary flavor-mixing matrix is a CKM matrix.

10. The method of claim 9, wherein the fixed integer ladder assignments comprise u=0, d=1, c=11, s=10, t=30, and b=31.

11. The method of claim 1, wherein the unitary flavor-mixing matrix is a PMNS matrix.

12. The method of claim 11, wherein the fixed integer ladder assignments comprise e=0, mu=9, tau=11, nu_1=3, nu_2=10, and nu_3=23.

13. The method of claim 1, wherein the unitarising produces a unitary flavor-mixing matrix whose Hermitian transpose multiplied by the matrix equals the identity matrix within a selected numerical tolerance that is predetermined in a configuration record, stored in memory, or provided as a request parameter associated with the matrix-generation request.

14. The method of claim 1, further comprising computing a unitarity-error value based on deviation of the Hermitian transpose of the matrix multiplied by the matrix from the identity matrix and outputting an accept-or-reject indicator according to whether the unitarity-error value satisfies the selected numerical tolerance.

15. The method of claim 14, wherein the unitarity-error value is computed using a Frobenius norm, a maximum-entry norm, or a spectral norm.

16. The method of claim 1, wherein no fitted mixing angles or fitted CP phases are used once the fixed integer ladder assignments and the deterministic phase-gauge rule are fixed.

17. The method of claim 1, further comprising outputting an intermediate raw magnitude matrix prior to phase assignment, prior to unitarisation, or both.

18. A system for generating a unitary flavor-mixing matrix, comprising: ladder-index lookup storage storing fixed integer ladder assignments for source states and target states; Delta n computation logic configured to determine, for each matrix position, ladder-index differences for paired source states and target states; raw-magnitude determination logic configured to determine, for each matrix position, raw matrix-element magnitudes according to mag_ij=X_opt^{∧}(abs(Delta_n_ij)/4); deterministic phase-assignment logic configured to assign complex phases according to a deterministic phase-gauge rule to produce a complex provisional matrix; and unitarisation logic configured to generate a unitary flavor-mixing matrix from the complex provisional matrix.

19. The system of claim 18, wherein the unitary flavor-mixing matrix is selectively generated as a CKM matrix or a PMNS matrix using different fixed ladder tables and the same exact raw-magnitude rule.

20. A non-transitory computer-readable medium storing instructions that, when executed by one or more processors, cause the one or more processors to perform operations comprising:
accessing fixed integer ladder assignments for a plurality of source states and a plurality of target states; pairing the source states and the target states to define matrix positions; determining, for each matrix position, a ladder-index difference between a ladder assignment of a corresponding source state and a ladder assignment of a corresponding target state; determining, for each matrix position, a raw matrix-element magnitude according to mag_ij=X_opt^{∧}(abs(Delta_n_ij)/4); assigning complex phases to the raw matrix-element magnitudes according to a deterministic phase-gauge rule to produce a complex provisional matrix; and unitarising the complex provisional matrix to produce a unitary flavor-mixing matrix.
